(19) United States
(12) Patent Application Publication
(10) Pub. No.: US 2012/0256063 A1
(43) Pub. Date: Oct. 11, 2012

(54) ARRANGEMENT FOR POSITIONING SUSPENDED PROFILED ELEMENTS IN DRY CONSTRUCTION

(76) Inventor: Josef Weber, Zell (DE)

(21) Appl. No.: 13/508,144

(22) PCT Filed: Sep. 24, 2010
(86) PCT No.: PCT/DE2010/001140

§ 371 Date: Jun. 20, 2012

(30) Foreign Application Priority Data
Nov. 6, 2009 (DE) 20 2009 015 143.3

(51) Int. Cl. F16M 13/00; F16B 1/00

(52) U.S. Cl. 248/206.5; 248/323

(57) ABSTRACT

The invention relates to an arrangement for positioning suspended construction elements in dry construction consisting of at least one metal suspended element (2) with a receiving area (2.1) and one metal construction element (3) received in a receiving area (2.1) of the suspended element (2). Advantageously, the suspended element (2) is associated with a positioning element (1) with magnetic means (4, 5), wherein the magnetic forces caused by the magnetic means (4, 5) act on the suspended element (2) and/or the construction element (3) so that by means of the positioning element (1) the construction element (3) is movably fastened in relation to the suspended element (2).

The invention relates to an arrangement for positioning suspended construction elements in dry construction according to the preamble of claim 1.

In dry construction or acoustic construction it is sufficiently known in the art to arrange suspended construction elements on ceilings or roof sub-constructions for fastening of additional elements, in particular flat elements such as panels or gypsum plaster boards. For this purpose first a plurality of suspended elements, for example in the form of directly suspended elements are attached to the ceiling or the roof sub-construction, namely in rows at a distance from each other. The suspended elements have in particular a U-shaped receiving area that is bounded on the sides by legs, and this area is open toward the side facing away from the ceiling or the roof sub-construction. Construction elements are then inserted into the receiving areas of the suspended elements arranged in rows. The construction elements are for example metal profiled elements, in particular CD-profiled elements. Due to the U-shaped design of the suspended elements, the height of the construction elements can be adjusted by moving the profiled elements within the receiving area to change their distance from the ceiling or the roof sub-construction.

In order to align the construction elements, which are arranged next to each other and at a distance from each other, to a reference plane, which is specified for example by a leveling laser, the distance from the bottom edge of the construction element to the reference plane must be measured. After setting a desired distance to the reference plane the construction element is connected to the suspended element for example by inserting lateral screws penetrating the legs of the suspended elements. Due to the necessity of simultaneously adjusting, fixing and fastening the construction elements in relation to the suspended elements, it was necessary especially in the case of construction elements with a substantial length for two workers to perform these tasks, one worker aligning and fixing the construction element while the other worker fastens the element. This makes it expensive to carry out this work due to the high manpower requirements.

Based on this, the object of the invention is to present an arrangement for positioning of suspended construction elements by means of which it is possible for one worker to align such construction elements at a defined distance to a reference plane, therefore significantly reducing costs. This object is achieved based on the characteristics of the preamble of claim 1.

The essential aspect of the arrangement according to the invention is that the suspended element is associated with a positioning element with magnetic means and that the magnetic forces created by the magnetic means act on the suspended element and/or the construction element so that by means of the positioning element the construction element is movably fixed in relation to the suspended element.

In a preferred embodiment the positioning element has a basic form that is essentially T-shaped when viewed in cross section. It consists of one first and second positioning element area, the first positioning element area being adapted to the width of the receiving space of the suspended element and the second positioning element area having a smaller width in comparison to the first positioning element area. Due to this design the positioning element can be inserted into the receiving space that is circumferentially limited by the suspended element and the construction element placed in the recesses in the sub-areas of the positioning element resulting from the smaller width of the second positioning element area.

Further advantageous embodiments of the invention are the subject of the dependent claims. The invention is described in more detail below based on an exemplary embodiment with reference to several drawings, wherein:

FIG. 1 shows a schematic representation of a construction element fastened to a ceiling by means of suspended elements;

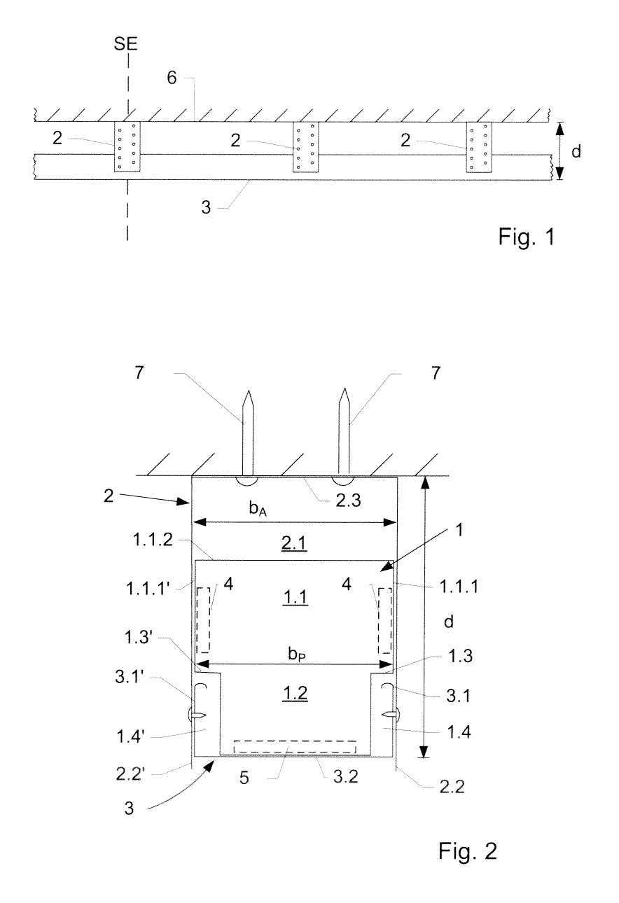

FIG. 2 shows a side view in cross section of an arrangement according to the invention with positioning elements inserted within the suspended element and construction element;

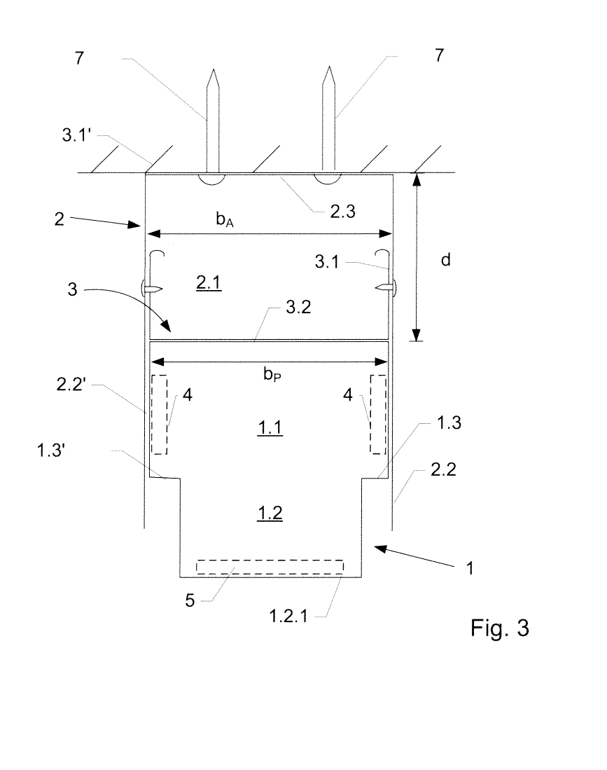

FIG. 3 shows a side view in cross section of a further possibility of an arrangement according to the invention with a positioning element arranged beneath the construction element.

FIG. 1 shows a cutout view of a construction element 3 arranged on a ceiling 6 by means of a plurality of suspended elements 2 as used in particular in dry construction. The suspended elements 2 are fastened to the ceiling or to the roof sub-construction 6, in particular bolted thereto. The construction element 3 can be moved in relation to the suspended element 2 so that the bottom edge of the construction element 3 can be arranged for example at a constant distance d from the ceiling 6 or at a defined angle to the ceiling 6. The alignment of the construction element 3 is achieved for example based on measurement of a distance to a reference level, which can be defined for example by an alignment wire or a leveling laser. Fastening of the construction elements 3 in relation to the suspended elements 2 is achieved by screwing means, which are inserted into the construction element 3 through holes made in the suspended element 2.

FIG. 2 shows, along the cutting plane SE shown in FIG. 1, an arrangement according to the invention for positioning suspended construction elements in dry construction. The arrangement consists of a metal suspended element 2 with a receiving area 2.1 in which a metal construction element 3 is arranged.

According to the idea on which the invention is based the suspended element 2 is associated with a positioning element 1 with magnetic means 4, 5, wherein the magnetic forces caused by the magnetic means 4, 5 act on the suspended element 2 and/or the construction element 3 so that by means of the positioning element 1 the construction element 3 is movably fastened in relation to the suspended element 2. Due to this movable fixing of the construction element 3 in relation to the suspended element 2 the distance d between the bottom edge of the construction element 3 and the ceiling 6 can vary during installation of the construction element 3. This allows the worker to achieve optimal alignment of the construction element 3 in relation to a reference plane defined for example by a leveling laser. Afterwards the respective aligned construction element 3 can be tightly connected with the suspended element 2, for example by screw connections. This ensures that the single construction elements 3, which are arranged next to each other and at a distance from each other, come to lie with their bottom edges in a defined, desired plane.

In a preferred embodiment the suspended element 2 has a U-shaped design and comprises a bottom area 2.3 provided for contact with the ceiling 6, from which (bottom area) the legs 2.2, 2.2′ protrude downward preferably at a right angle or essentially a right angle. The two legs 2.2, 2.2′ extend essentially parallel to each other and laterally limit the receiving area 2.1, which has a width b_{A}, between the two legs. Further, the construction element 3 is designed as a U-shaped profiled element with legs 3.1, 3.1′ and a bottom area 3.2 and has a width b_{P}, which is adapted to the exact size of the width b_{A} of the receiving area 2.1. This makes it possible to insert the profiled element 3 into the receiving area 2.1 of the suspended element 2, the outer sides of the legs 3.1, 3.1′ of the construction element 3 bearing against the inner sides of the legs 2.2, 2.2′ of the suspended element 2. The construction element, laterally guided between the legs 2.2, 2.2′, can therefore be adjusted in relation to its distance d from the ceiling 6.

Preferably the U-shaped construction element 3 is inserted into the receiving area 2.1 so that the construction element 3 opens in the opposite direction in relation to the U-shaped suspended element 2. The bottom area 3.2 forms the bottom edge of the construction element 3, so that the panels or gypsum plaster boards to be fastened to the construction element 3 lying on the bottom area 3.2 can be screwed to the latter.

The positioning element 1 is inserted into the receiving space enclosed by the bottom area 2.3, the legs 2.2, 2.2′ of the suspended element 2 and the legs 3.1, 3.1′ and the bottom area 3.2 of the construction element 3. This positioning element 1 comprises one first positioning element area 1.1, whose width is adapted to the exact size of the width b_{A} of the receiving area 2.1 of the suspended element 2. The side surface 1.1.1, 1.1.1′ of the first positioning element area 1.1 bear against the inner sides of the legs 2.2, 2.2′ of the suspended element 2. In the depicted embodiment, in the immediate vicinity of these side surfaces 1.1.1, 1.1.1′ single magnets 4 are arranged respectively, namely so that the magnetic forces of the magnets 4 act perpendicularly on the side surfaces 1.1.1, 1.1.1′. Therefore they cause an attraction of the positioning element 1 in relation to the metal suspended element 2, thus fixing the positioning element 1 in relation to the suspended element 2. Instead of separate magnets 4 a single magnet can be arranged in the first positioning element area 1.1, which (magnet) extends for example approximately across the entire width of the first positioning element area 1.1.

The positioning element 1 comprises in addition to the first positioning element area 1.1 one second positioning element area 1.2, which has a smaller width than the first positioning element area 1.1. The second positioning element area 1.2 is centered in relation to the first positioning element area 1.1, the two areas overlapping by means of gradations 1.3, 1.3′. The gradations 1.3, 1.3′ produce recesses 1.4, 1.4′, which are designed so that also flanged or beaded legs 3.1, 3.1′ of the construction element 3 can be inserted into the recesses and therefore fixed by the positioning element 1.

For fixing of the construction element 3 by means of the positioning element 1 the second positioning element area 1.2 comprises a magnet 5 in the area of its bottom surface 1.2.1, which (magnet) attracts the bottom surface 3.2 of the construction element 3 bearing against the bottom surface 1.2.1 by means of magnetic forces, thus fixing the construction element 3 to the positioning element 1. Therefore, due to the positioning element 1 with its magnets 4, 5, whose magnetic forces preferably act at right angles to each other, the construction element 3 is fixed and held in relation to the suspended element 2. The magnetic forces of the magnets 4 are dimensioned so that the positioning element 1 together with the construction element 3 held by the magnets 5 is sufficiently secured against falling, yet the movability of the positioning element 1 in relation to the suspended element 2 is possible without great expenditure of force.

FIG. 3 shows a further possibility for an arrangement of the positioning element 1 in the suspended element 2. In this case the positioning element 1 is arranged beneath the construction element 3, so that the bottom area 3.2 of the construction element 3 bears against the top surface 1.1.2 of the positioning element 1. The positioning element 1, which is held by its magnets 4 on the legs 2.2, 2.2′ of the suspended element 2, absorbs the gravity of the construction element 3 and secures the latter against falling out of the receiving area 2.1 which is open toward the bottom.

In the following, the use of a positioning element 1 in an arrangement according to the invention is described in more detail. First, a plurality of suspended elements 2 are fastened on a ceiling 6 or a roof sub-construction in a row and in alignment, for example with screws 7. Afterwards, the construction element 3 is inserted into the receiving area 2.1 of the respective suspended elements 2, this construction element 3 being secured on at least two suspended elements 2 by means of the positioning element 1 against falling out of the suspended element 2. In the case of construction elements 3 with a long length it may be necessary to fix this construction element 3 on at least one additional suspended element 2 to prevent sagging of the construction element 3. Depending on the desired distance d of the bottom area 3.2 of the construction element 3 from the ceiling 6, the positioning element 1 can be arranged above the construction element 3, so that this construction element 3 is fixed by the magnets 5 or that the positioning element 1 is arranged beneath the construction element 3 and the latter lies on the positioning element 1.

Fixing the construction element 3 by means of the positioning elements 1 is followed by alignment of the same, for example to a reference plane, which is defined by a leveling laser. For this purpose the construction element 3, which is held at points by the positioning elements 1, can be moved within the suspended elements 2. After completion of the alignment, the construction element 3 is fastened by screws inserted into the legs 2.2, 2.2′ of the suspended element 2. Afterwards, the positioning elements 1 can be disconnected from the suspended elements 2 and the construction element 3 and removed. In the event that the legs 2.2 of the suspended element 2 protrude over the bottom area 3.2 of the construction element 3, these protrusions can be eliminated for example by bending the legs 2.2, 2.2′ outward or by cutting off the protrusions. This allows construction elements 3 arranged consecutively at a distance from each other to be aligned in relation to a reference plane with minimal manpower requirements.

The positioning element 1 can be manufactured from steel, aluminum or plastic. For easier movability of the positioning element 1 in relation to the legs 2.2, 2.2′ of the suspended element 2, the side surfaces 1.1.1, 1.1.1′ of the positioning element 1 are preferably designed for gliding. This can be achieved for example by a special glide coating or by polishing of the two side surfaces 1.1.1, 1.1.1′.

It is also advantageous to provide a scale on the positioning element 1, to allow at least a general alignment of the same within the construction element 3. Preferably the scale is provided on the front faces, which are for example T-shaped, so that this scale is visible also after insertion of the positioning element 1 into the construction element 3.

The invention was described above based on an exemplary embodiment. It goes without saying that numerous modifications and variations of the invention are possible without abandoning the underlying inventive idea.

### REFERENCE LIST

1 positioning element
1.1 first positioning elemen area
1.1.1, 1.1.1′ side surface
1.1.2 top surface
1.2 second positioning element area
1.2.1 bottom surface
1.3, 1.3′ gradation
1.4, 1.4′ recess
2 suspended element
2.1 receiving area
2.2, 2.2′ leg
2.3 bottom area
3 construction element
3.1, 3.1′ leg
3.2 bottom area
4 magnet
5 magnet
6 ceiling
7 screws
b_{P} width
b_{A} width
d distance
SE cutting plane

1. An arrangement for positioning suspended construction elements in dry construction comprising:
at least one metal suspended element (2) with a receiving area (2.1) and one metal construction element (3) received in a receiving area (2.1) of the suspended element (2), characterized in that the suspended element (2) is associated with a positioning element (1) with magnetic means (4, 5) and that the magnetic forces caused by the magnetic means (4, 5) act on the suspended element (2) and the construction element (3) so that by means of the positioning element (1) the construction element (3) is movably fastened in relation to the suspended element (2).

2. Arrangement according to claim 1, characterized in that the suspended element (2) is U-shaped with two legs (2.2, 2.2′) extending parallel to each other and that the area enclosed by the legs (2.2, 2.2′) forms the receiving area (2.1) for the construction element (3).

3. The arrangement according to claim 1, characterized in that the construction element (3) is a U-shaped or essentially U-shaped profiled element, whose width (b_{P}) is adapted to the exact size of the width (b_{A}) of the receiving area (2.1) of the suspended element (2).

4. The arrangement according to claim 3, characterized in that the construction element (3) is arranged in the suspended element (2) so that the construction element (3) and the suspended element (2) open in opposite directions.

5. The arrangement according to claim 1, characterized in that the positioning element (1) comprises one first positioning element area (1.1), which is adapted to the exact size of the width (b_{A}) of the receiving area (2.1) of the suspended element (2).

6. The arrangement according to claim 5, characterized in that the positioning element (1) comprises one second positioning element area (1.2), which has a smaller width than the first positioning element area (1.1).

7. The arrangement according to claim 5, characterized in that the positioning element (1) in the first positioning element area (1.1) comprises at least one magnet (4), which is designed and/or positioned so that the positioning element (1) arranged in the receiving area (2.1) is held by the magnetic forces acting on the legs (2.2, 2.2′) of the suspended element (2).

8. The arrangement according to claim 6, characterized in that the positioning element (1) in the second positioning element area (1.2) comprises at least one magnet (5), which is designed and/or positioned so that the construction element (3) bearing against the second positioning element area (1.2) is held by the magnetic forces.

9. The arrangement according to claim 1, characterized in that the positioning element (1) is received within the receiving space limited circumferentially by the suspended element (2) and the construction element (3).

10. The arrangement according to claim 1, characterized in that the positioning element (1) is arranged beneath the receiving space limited circumferentially by the suspended element (2) and the construction element (3) and the construction element (3) rests on the positioning element (1).

11. An arrangement for positioning suspended construction elements in dry construction comprising:
at least one metal suspended element (2) with a receiving area (2.1) and one metal construction element (3) received in a receiving area (2.1) of the suspended element (2), characterized in that the suspended element (2) is associated with a positioning element (1) with magnetic means (4, 5) and that the magnetic forces caused by the magnetic means (4, 5) act on the construction element (3) so that by means of the positioning element (1) the construction element (3) is movably fastened in relation to the suspended element (2).

12. Arrangement according to claim 11, characterized in that the suspended element (2) is U-shaped with two legs (2.2, 2.2′) extending parallel to each other and that the area enclosed by the legs (2.2, 2.2′) forms the receiving area (2.1) for the construction element (3).

13. The arrangement according to claim 11, characterized in that the construction element (3) is a U-shaped or essentially U-shaped profiled element, whose width (b_{P}) is adapted to the exact size of the width (b_{A}) of the receiving area (2.1) of the suspended element (2).

14. The arrangement according to claim 13, characterized in that the construction element (3) is arranged in the suspended element (2) so that the construction element (3) and the suspended element (2) open in opposite directions.

15. The arrangement according to claim 11, characterized in that the positioning element (1) comprises one first positioning element area (1.1), which is adapted to the exact size of the width (b_{A}) of the receiving area (2.1) of the suspended element (2).

16. The arrangement according to claim 15, characterized in that the positioning element (1) comprises one second positioning element area (1.2), which has a smaller width than the first positioning element area (1.1).

17. The arrangement according to claim 15, characterized in that the positioning element (1) in the first positioning element area (1.1) comprises at least one magnet (4), which is designed and/or positioned so that the positioning element (1) arranged in the receiving area (2.1) is held by the magnetic forces acting on the legs (2.2, 2.2′) of the suspended element (2).

18. The arrangement according to claim 16, characterized in that the positioning element (in the second positioning element area (1.2) comprises at least one magnet (5), which is designed and/or positioned so that the construction element (3) bearing against the second positioning element area (1.2) is held by the magnetic forces.

19. The arrangement according to claim 11, characterized in that the positioning element (1) is received within the receiving space limited circumferentially by the suspended element (2) and the construction element (3).

20. The arrangement according to claim 1, characterized in that the positioning element (1) is arranged beneath the receiving space limited circumferentially by the suspended element (2) and the construction element (3) and the construction element (3) rests on the positioning element (1).
